(19) United States
(12) Patent Application Publication
(10) Pub. No.: US 2026/0133558 A1
(43) Pub. Date: May 14, 2026

(54) METHOD AND APPARATUS FOR RETRAINING DETECTION MODEL, AND NON-TRANSITORY COMPUTER-READABLE STORAGE MEDIUM

(71) Applicant: WISTRON CORPORATION, New Taipei City (TW)

(72) Inventor: Yuan Fu HUANG, New Taipei City (TW)

(73) Assignee: WISTRON CORPORATION, New Taipei City (TW)

(21) Appl. No.: 19/026,965

(22) Filed: Jan. 17, 2025

(30) Foreign Application Priority Data
Nov. 11, 2024 (TW) 113143265

(51) Int. Cl. G05B 19/4063; G06N 3/0464

(52) U.S. Cl. CPC G05B 19/4063; G05B 2219/42155; G06N 3/0464

(57) ABSTRACT

A method and an apparatus for retraining a detection model, and a non-transitory computer-readable storage medium are provided. The method includes obtaining accuracy information of an object detection model. The method further includes retraining the object detection model based on an accuracy supervision model estimate that indicates the accuracy information is abnormal.

### CROSS-REFERENCE TO RELATED APPLICATION

This application claims the priority and benefit of Taiwan Patent Application No. 113143265, filed on Nov. 11, 2024, the disclosure of which is hereby incorporated in its entirety by reference herein.

### Technical Field

The present application relates to a model training method, and in particular, to a method and an apparatus for retraining a detection model that can find a time point at which an object detection model needs to be retrained, and a non-transitory computer-readable storage medium.

### BACKGROUND

### Related Art

At present, in industrial manufacturing, whether a product is defective is usually identified by using a visual inspection technology. However, as time goes by, increasingly diversified inspection data is generated, while a detection model cannot identify unknown data. As a result, identification accuracy exceeds a range of a production line standard, and production quality declines. In this case, the detection model needs to be retrained to adapt to a new data environment.

### SUMMARY

An embodiment of the present application provides a method for retraining a detection model, performed by a computing apparatus, the method including: obtaining accuracy information of an object detection model; and retraining the object detection model based on an accuracy supervision model estimate that indicates the accuracy information is abnormal.

An embodiment of the present application provides a non-transitory computer-readable storage medium, storing a plurality of instructions loaded to perform the foregoing method for retraining a detection model.

An embodiment of the present application provides an apparatus for retraining a detection model, including: an input unit and a computing unit. The input unit is configured to obtain accuracy information of an object detection model. The computing unit is configured to retrain the object detection model based on an accuracy supervision model estimate that indicates the accuracy information is abnormal.

According to the method and apparatus for retraining a detection model and the non-transitory computer-readable storage medium of some embodiments of the present application, a decline in efficiency of the object detection model can be observed by using the accuracy supervision model to trigger retraining of the object detection model.

### BRIEF DESCRIPTION OF THE DRAWINGS

FIG. 1 is a schematic architectural diagram of an apparatus for retraining a detection model according to an embodiment of the present application;

FIG. 2 is a flowchart of a method for retraining a detection model according to an embodiment of the present application;

FIG. 3 is a flowchart of a method for detecting a product defect according to an embodiment of the present application;

FIG. 4 is a schematic diagram of supervising efficiency of an object detection model according to an embodiment of the present application;

FIG. 5 is a schematic diagram of comparison between an identified type and an actual type according to an embodiment of the present application;

FIG. 6 is a flowchart of determining a decline in performance of an object detection model according to an embodiment of the present application;

FIG. 7 is a schematic diagram of a leakage rate of a normal test set according to an embodiment of the present application;

FIG. 8 is a schematic diagram of a leakage rate of an abnormal test set according to an embodiment of the present application;

FIG. 9 is a schematic diagram of an overkill rate of a normal test set according to an embodiment of the present application;

FIG. 10 is a schematic diagram of an overkill rate of an abnormal test set according to an embodiment of the present application;

FIG. 11 is a flowchart of implementing an accuracy supervision model according to an embodiment of the present application; and

FIG. 12 is a diagram of change in an overkill rate of an object detection model according to an embodiment of the present application.

### DETAILED DESCRIPTION

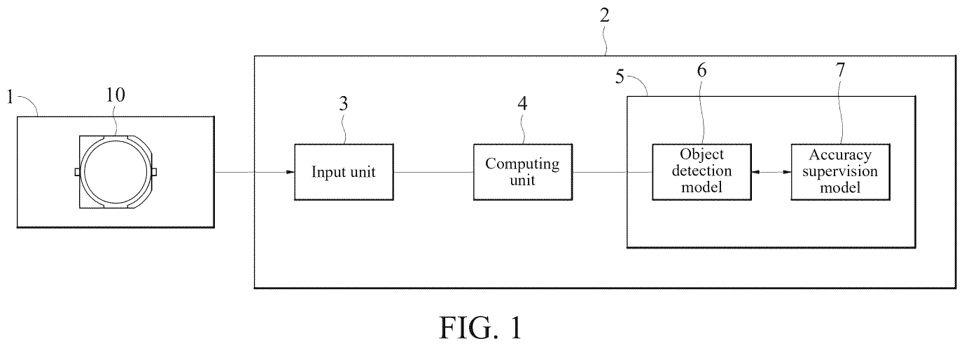

FIG. 1 is a schematic architectural diagram of an apparatus 2 for retraining a detection model according to an embodiment of the present application. The retraining apparatus 2 includes an input unit 3, a computing unit 4, and a non-transitory computer-readable storage medium 5. The computing unit 4 is coupled to the input unit 3 and the non-transitory computer-readable storage medium 5. The computing unit 4 is configured to obtain a plurality of product photos 1 via the input unit 3. The product photos 1 are obtained by respectively photographing a plurality of products 10 of the same product type. The non-transitory computer-readable storage medium 5 stores machine learning models such as an object detection model 6 and an accuracy supervision model 7. In addition, the non-transitory computer-readable storage medium 5 further stores a plurality of instructions (not shown in the figure), and the instructions are loaded by the computing unit 4 to perform a method for retraining a detection model. In some embodiments, the product 10 is an electronic element, such as a capacitor, a resistor, or an inductor. In some embodiments, the object detection model 6 is a Yolo (you only look once) model, but the present application is not limited thereto.

In some embodiments, the retraining apparatus 2 is a client-server architecture. The input unit 3 is a client, and the computing unit 4 and the non-transitory computer-readable storage medium 5 form a server end to receive the product photos 1 uploaded by the input unit 3. The server end may be implemented by one or more servers. For example, the object detection model 6 and the accuracy supervision model 7 may be located in the same server. For another example, the object detection model 6 and the accuracy supervision model 7 are each independently located in a server. When there is a plurality of object detection models 6 or a plurality of accuracy supervision models 7, some or all of the object detection models 6 may be in a same server, and some or all of the accuracy supervision models 7 may be in a same server.

In some embodiments, the retraining apparatus 2 is a single-node architecture, and the input unit 3 is a storage interface, a wired communication interface, or a wireless communication interface, to be coupled to a data source (for example, a hard disk or a cloud hard disk).

In some embodiments, the input unit 3 receives the product photos 1 provided by the data source. The data source is an automated optical inspection (AOI) device.

In some embodiments, the computing unit 4 may be an integrated circuit chip, for example, a central processing unit (CPU), a tensor processing unit (TPU), a digital signal processor (DSP), an application-specific integrated circuit (ASIC), a field-programmable gate array (FPGA), or another programmable logic apparatus.

In some embodiments, the non-transitory computer-readable storage medium 5 includes one or more non-transitory storage media. The non-transitory storage medium includes, for example but not limited to, a phase-change random access memory (PRAM), a static random access memory (SRAM), a dynamic random access memory (DRAM), or another type of random access memory (RAM), a read-only memory (ROM), an electrically erasable programmable read-only memory (EEPROM), a flash memory, or another memory technology, a compact disc read-only memory (CD-ROM), a digital versatile disc (DVD), or another optical storage, a cassette magnetic tape, a tape or disk storage, or another magnetic storage device, or any other non-transmission medium that can be used to store information accessible to a computing device.

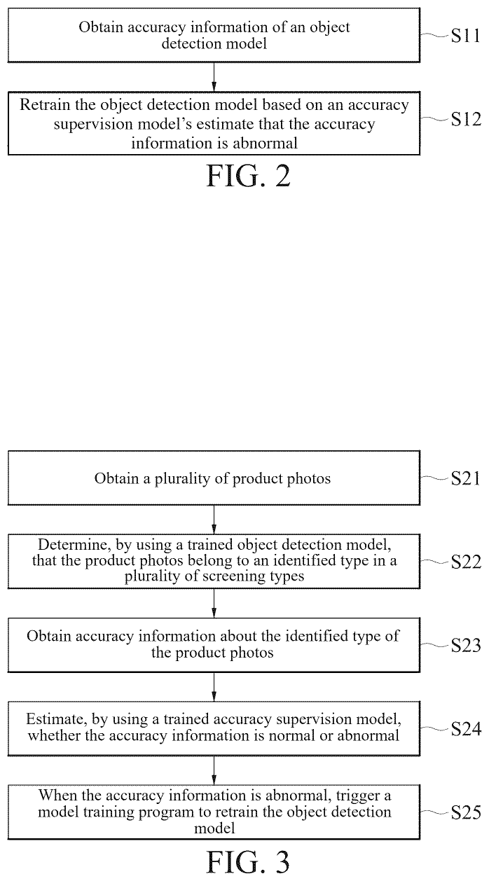

FIG. 2 is a flowchart of a method for retraining a detection model according to an embodiment of the present application. The method for retraining a detection model is performed by the computing unit 4. Step S11: Obtain accuracy information of the object detection model 6. Herein, the object detection model 6 is a trained model and can perform object detection. The accuracy information is an indicator of accuracy of detecting an object by the object detection model 6. Step S12: Retrain the object detection model 6 based on the accuracy supervision model 7 estimate that indicates the accuracy information is abnormal. Therefore, based on an estimation result of the accuracy supervision model 7, it can be found that accuracy of the object detection model 6 is abnormal (that is, detection efficiency is low), and the object detection model 6 is retrained. The following describes application of the retraining apparatus 2 and the retraining method in product defect detection, that is, an apparatus and method for detecting a product detect.

FIG. 3 is a flowchart of a method for detecting a product defect according to an embodiment of the present application. The method for detecting a product defect is performed by the computing unit 4. The foregoing step S11 may be specifically implemented through step S21 to step S23. The foregoing step S12 may be specifically implemented through step S24 and step S25. Step S21: Obtain a plurality of product photos 1 via the input unit 3. Step S22: Determine, by using the trained object detection model 6, that the product photos 1 belong to one (referred to as an identified type below) of a plurality of screening types. Step S23: Obtain accuracy information about the identified type of the product photos 1. Step S24: Estimate, by using the trained accuracy supervision model 7, whether the accuracy information is normal or abnormal, to determine whether efficiency of the object detection model 6 declines. Step S25: When the accuracy information is abnormal, trigger a model training program to retrain the object detection model 6. Therefore, it can be actively found that efficiency of the object detection model 6 declines, to trigger retraining of the object detection model 6.

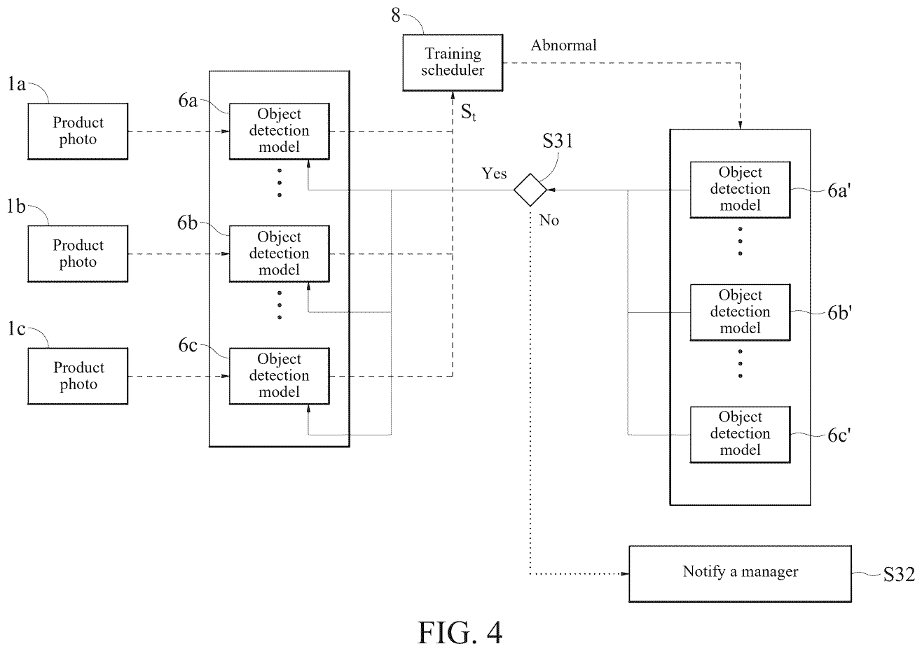

FIG. 4 is a schematic diagram of supervising efficiency of object detection models 6a to 6c according to an embodiment of the present application. Herein, the plurality of object detection models 6a to 6c (three are used as an example) are presented and obtain a plurality of product photos 1a to 1c respectively. In FIG. 4, the product photo 1a represents a plurality of product photos 1 obtained by photographing a plurality of products 10 of a first product type; the product photo 1b represents a plurality of product photos 1 obtained by photographing a plurality of products 10 of a second product type; and the product photo 1c represents a plurality of product photos 1 obtained by photographing a plurality of products 10 of a third product type. The product types may be distinguished based on differences between types, models, functions, and/or the like of electronic elements. The object detection models 6a to 6c are respectively trained by using training sets of different product types, and the used training sets respectively correspond to the product types of the product photos 1a to 1c for determining.

In some embodiments, the object detection models 6a to 6c are a same machine learning model. In some other embodiments, machine learning models used by the object detection models 6a to 6c may be different.

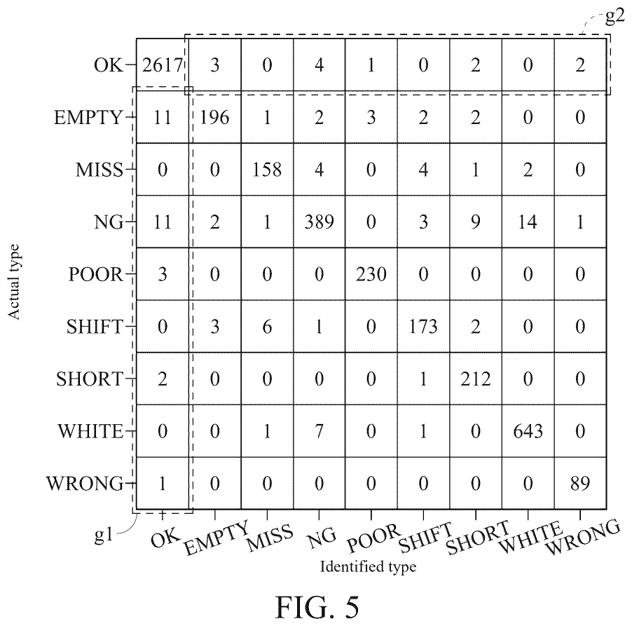

FIG. 5 is a schematic diagram of comparison between an identified type and an actual type according to an embodiment of the present application. FIG. 5 shows comparison between statistics of screening types identified by the object detection model 6 for the plurality of product photos 1 and statistics of actual screening types of the product photos 1. The screening types described herein include an “OK” (normal) type, an “EMPTY” (empty solder) type, a “MISS” (missing a part) type, an “NG” (not good) type, a “POOR” (poor solder) type, a “SHIFT” (shift) type, a “SHORT” (short circuit) type, a “WHITE” (white part) type, and a “WRONG” (wrong) type, but the present application is not limited thereto. Screening types that can be identified by the object detection model 6 may be some of the screening types, and/or include other screening types that are not shown. The “EMPTY” type, the “MISS” type, the “NG” type, the “POOR” type, the “SHIFT” type, the “SHORT” type, the “WHITE” type, and the “WRONG” type are defect types, and the “NG” type is a type that cannot be classified as another specific defect type and is not the normal type.

A value in a box g1 refers to a quantity of types that are identified as the normal type but are actually defect types. A total of such quantities is a leakage quantity. A leakage rate may be calculated by comparing the leakage quantity with a total quantity.

A value in a box g2 refers to a quantity of types that are identified as defect types but are actually the normal type. A total of such quantities is an overkill quantity. An overkill rate may be calculated by comparing the overkill quantity with the total quantity.

In some embodiments, the recorded data is provided to the computing unit 4 via the input unit 3. The computing unit 4 calculates the overkill rate and the leakage rate.

As shown in FIG. 4, accuracy information Sₜ corresponding to the object detection models 6a to 6c is inputted to a training scheduler 8. The training scheduler 8 includes a trained accuracy supervision model 7 shown in FIG. 1 to identify whether the object detection models 6a to 6c are abnormal (efficiency declines). The accuracy information Sₜ is sequential data, and may be represented by Formula 1, where n is a natural number (such as 60, 120, or 300). To be specific, the accuracy information Sₜ includes a plurality of pieces of time point accuracy data Pₜ₋ₙ to Pₜ. Each piece of time point accuracy data Pₜ₋ₙ to Pₜ is accuracy information calculated based on a screening type determined by an object detection model 6 within a period of time before a certain time. Each piece of time point accuracy data includes an overkill rate and a leakage rate, expressed in a vector form.

$${S}_{t} = \{ {P}_{t - n} , {P}_{t - n + 1} , … , {P}_{t} \} \qquad Formula 1$$

In some embodiments, the accuracy supervision model 7 is a classification model that may perform label prediction based on input information (the accuracy information Sₜ) to classify the input information as normal or abnormal, for example, a support vector machine (SVM), a random forest, a classification tree, or a multilayer perceptron (MLP).

In some embodiments, the accuracy supervision model 7 is an encoder-decoder model, for example, a neural network model with an encoder-decoder architecture, such as an autoencoder or a transformer. The autoencoder is used as an example. An objective of the autoencoder is to satisfy Formula 2, where g_{φ} represents an encoder, ƒ_{θ} represents a decoder, Sₜ is accuracy information inputted to the encoder, and

$${S}_{t}^{′}$$

is accuracy estimation information outputted by the decoder. Formula 2 means that the encoder compresses the accuracy information Sₜ, and then the decoder reconstructs the accuracy estimation information

$${S}_{t}^{′} .$$

In a normal case, accuracy estimation information

$${S}_{t}^{′}$$

approaches Sₜ. Conversely, if the accuracy estimation information

$${S}_{t}^{′}$$

does not approach the accuracy information Sₜ, an abnormal case occurs.

$${S}_{t}^{′} = {f}_{θ} {g}_{φ} ( {S}_{t} ) \qquad Formula 2$$

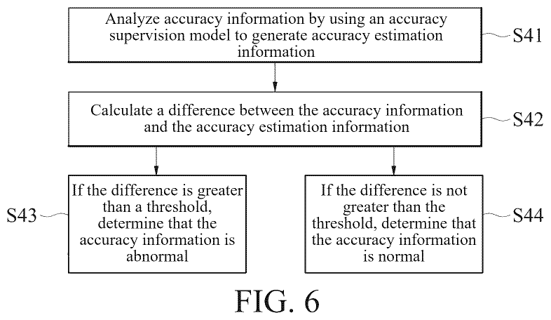

FIG. 6 is a flowchart of determining a decline in performance of the object detection model 6 according to an embodiment of the present application, which may be included in step S24 of FIG. 3. Step S41: Analyze the accuracy information Sₜ by using the accuracy supervision model 7 to generate accuracy estimation information

$${S}_{t}^{′} .$$

Step 342: Calculate a difference (that is,

$$\vert {S}_{t}^{′} - {S}_{t} \vert )$$

between the accuracy information Sₜ and the accuracy estimation information

$${S}_{t}^{′} .$$

Then it is determined whether the difference is greater than a threshold. If the difference is greater than the threshold, it is determined that the accuracy information Sₜ is abnormal (step S43). If the difference is not greater than the threshold, it is determined that the accuracy information Sₜ is normal (step S44). In some embodiments, the threshold is determined based on a 97.5% quantile of a standard data set.

As shown in FIG. 4, when it is determined that the object detection model 6 is abnormal, the training scheduler 8 triggers a model training program for retraining the abnormal object detection model 6. The object detection models 6a′ to 6c′ respectively represent results of retraining the object detection models 6a to 6c. After the retraining is completed, in step S31, it is determined whether the retrained object detection models 6a′ to 6c′ meet a production line standard. If yes, the object detection models 6a′ to 6c′ are deployed in the retraining apparatus 2 to replace the original object detection models 6a to 6c with declining efficiency. If no, step S32 is performed to notify a manager for processing. Although the three object detection models 6a′ to 6c′ are shown herein, it does not mean that the three object detection models 6a to 6c need to be retrained at the same time, but instead, only an abnormal object detection model 6 needs to be retrained.

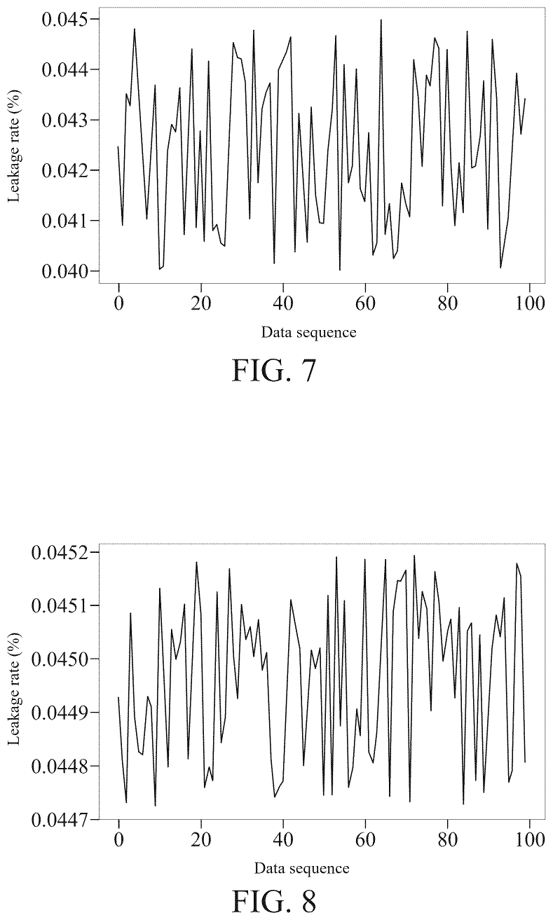

FIG. 7 and FIG. 8 are schematic diagrams of leakage rates of a normal test set and an abnormal test set according to an embodiment of the present application. If 0.045% is used as an upper standard limit of the leakage rate, most leakage rates shown in FIG. 7 are within a standard range, while many leakage rates shown in FIG. 8 exceed the upper standard limit. After being retrained, the object detection models 6a′ to 6c′ are tested by using a normal test set and an abnormal test set, respectively, based on the process of FIG. 6. If test results of the object detection models 6a′ to 6c′ for the normal test set are determined to be normal, and test results of the object detection models 6a′ to 6c′ for the abnormal test set are determined to be abnormal, it indicates that the object detection models 6a′ to 6c′ meet the production line standard. Conversely, the production line standard is not met.

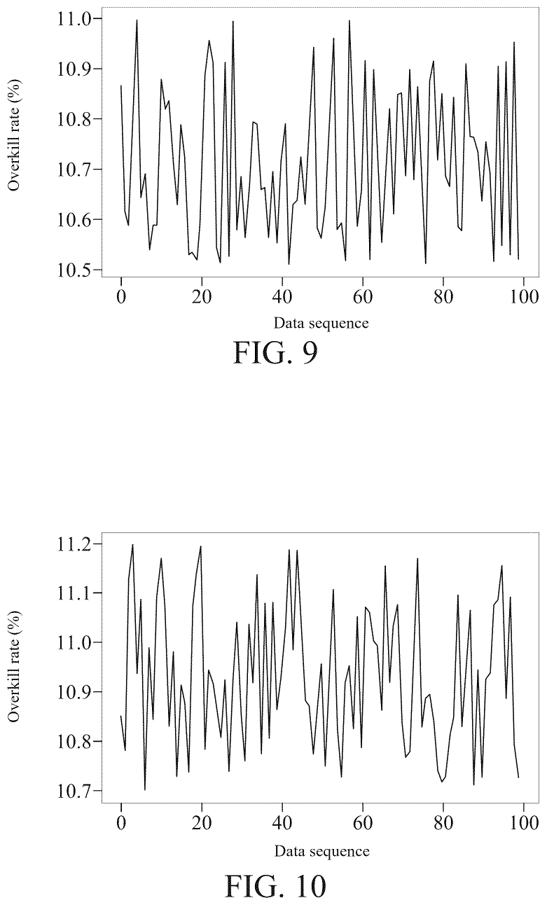

FIG. 9 and FIG. 10 are schematic diagrams of overkill rates of a normal test set and an abnormal test set according to an embodiment of the present application. If 11% is used as an upper standard limit of the overkill rate, most overkill rate shown in FIG. 9 are within a standard range, while many overkill rate shown in FIG. 10 exceed the upper standard limit. After being retrained, the object detection models 6a′ to 6c′ are tested by using a normal test set and an abnormal test set, respectively, based on the process of FIG. 6. If test results of the object detection models 6a′ to 6c′ for the normal test set are determined to be normal, and test results of the object detection models 6a′ to 6c′ for the abnormal test set are determined to be abnormal, it indicates that the object detection models 6a′ to 6c′ meet the production line standard. Conversely, the production line standard is not met.

It should be noted that, it can be seen from FIG. 7 and FIG. 9 that, even if the leakage rate or the overkill rate reaches or briefly exceeds the upper standard limit, the object detection model should still not be considered as abnormal. Therefore, if it is determined whether the leakage rate or the overkill rate exceeds the upper standard limit to determine whether the object detection model 6 is normal or abnormal, it cannot be correctly determined whether the efficiency of the object detection model 6 actually declines. Therefore, in the present application, the accuracy supervision model 7 is used to help correctly determine whether the efficiency of the object detection model 6 actually declines, so that the object detection model 6 is retrained when really necessary.

In some embodiments, the accuracy supervision model 7 is a recurrent neural network (RNN), for example, a long short-term memory (LSTM) model, which can extract a sequential change feature of the accuracy information Sₜ, and predict that the accuracy information Sₜ is about to be abnormal, so that the object detection model 6 can be trained in advance before getting abnormal, to avoid a wait for retraining when the accuracy information Sₜ is abnormal.

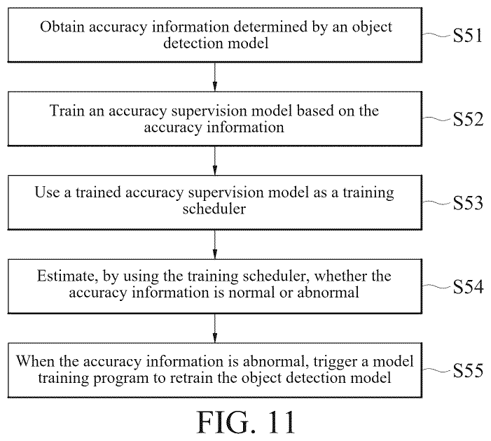

FIG. 11 is a flowchart of implementing the accuracy supervision model 7 according to an embodiment of the present application. Step S51: Obtain accuracy information Sₜ determined by the object detection model 6. Step S52: Train the accuracy supervision model 7 by using the accuracy information Sₜ obtained in step S51 as a training set. In some embodiments, the accuracy supervision model 7 (for example, a transformer or a multilayer perceptron, but the present application is not limited thereto) converges based on a triplet loss during training. During training, normal samples and abnormal samples are used, so that the accuracy supervision model 7 can generate close embeddings for a same type of data, and accordingly, the accuracy supervision model 7 learns an embedding space in which similar samples are close in space while dissimilar samples are far away from each other. The trained accuracy supervision model 7 converts the accuracy information Sₜ into an embedding. Based on a position of the embedding in the embedding space, the accuracy information Sₜ can be determined to be normal or abnormal.

Step S53: Deploy the trained accuracy supervision model 7 in the retraining apparatus 2 as the training scheduler 8. Step S54: Observe, by using the training scheduler 8, whether efficiency of the object detection model 6 declines (as described in step S24, identify whether the accuracy information Sₜ is abnormal). Step S55: When the accuracy information Sₜ is abnormal, trigger a model training program to retrain the object detection model 6 (as described in step S25).

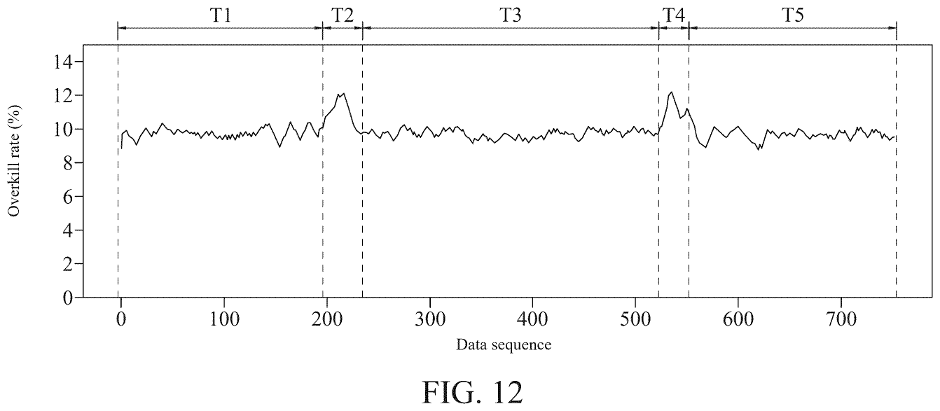

FIG. 12 is a diagram of change in an overkill rate of the object detection model 6 according to an embodiment of the present application. In an interval T1, the object detection model 6 works well, and can perform accurate detection, so that the overkill rate remains within a standard range (which is 11% or lower herein). As time goes by, products 10 gradually appear, whose defects belong to a screening type that cannot be determined by the object detection model 6. For example, in the interval T1, the object detection model 6 can determine only the “OK” type and the “MISS” type, and in the interval T2, a product 10 whose defect belongs to the “POOR” type appears. Therefore, the overkill rate rises (that is, efficiency of the object detection model 6 declines). After it is detected through the foregoing method that the object detection model 6 needs to be retrained in the interval T2, samples of the new defect type are added to a training set to retrain the object detection model 6. In this way, in an interval T3, the retrained object detection model 6 can identify the “OK” type, the “MISS” type, and the “POOR” type, so that the overkill rate recovers and remains within the standard range. In an interval T4, because another new defect type (for example, the “SHIFT” type) appears, the overkill rate rises (that is, the efficiency of the object detection model 6 declines). Therefore, samples of the new defect type are further added to the training set to retrain the object detection model 6, so that the overkill rate in an interval T5 recovers to the standard range again. In this way, compared with the object detection model 6 before retraining, the object detection model 6 after retraining has higher determining capabilities for screening types.

In some embodiments, when the object detection model 6 is retrained, a sample set used includes samples used in a previous training and detection samples accumulated after the previous training. For example, refer to FIG. 12 and Table 1 in combination. When the object detection model 6 is initially trained, 100 training samples are used. 200 detection samples are detected in the interval T1. When a quantity of accumulated detection samples in the interval T2 reaches 250 (including 200 in the interval T1), the model training program is triggered. In a second training, the detection samples accumulated in the interval T1 and the interval T2 (that is, the detection samples accumulated after the initial training, 250 in total) and samples in a previous training (that is, the samples in the initial training, 100) are used, 350 in total. After the second training, 300 new detection samples are obtained in the interval T3, and when a total of 350 (including 300 in the interval T3) are accumulated in the interval T4, the model training program is triggered again for a third training. In the third training, the detection samples accumulated in the interval T3 and the interval T4 (that is, the detection samples accumulated after the second training, 350 in total) and samples in a previous training (that is, the samples in the second training, 350 in total) are used, 700 in total. After the third training, 200 new detection samples are obtained in the interval T5.

TABLE 1

| | | |
|---|---|---|
| Initial | Second | Third |
| training | training | training |

Interval

| | T1 | T2 | T3 | T4 | T5 |
|---|---|---|---|---|---|
| Quantity of | 100 | | 350 | | 700 |
| training | | | | | |
| samples | | | | | |
| Quantity of | 200 | 250 | 300 | 350 | 200 |
| accumulated | | | | | |
| detection | | | | | |
| samples | | | | | |

According to the method and apparatus for retraining a detection model and the non-transitory computer-readable storage medium 5 of some embodiments of the present application, a decline in efficiency of the object detection model 6 can be observed by using the accuracy supervision model 7 to trigger retraining of the object detection model 6 without manually keeping monitoring.

What is claimed is:

1. A method for retraining a detection model, performed by a computing apparatus, the method comprising:
obtaining first accuracy information of an object detection model; and
retraining the object detection model based on an accuracy supervision model estimate that indicates the accuracy information is abnormal.

2. The method for retraining a detection model according to claim 1, further comprising:
obtaining a plurality of product photos, wherein the product photos are obtained by respectively photographing a plurality of products of a same product type;
determining, by the object detection model, that the product photos belong to an identified type in a plurality of screening types; and
obtaining second accuracy information of the identified type, wherein
the first accuracy information of the object detection model is the second accuracy information of the identified type of the product photos.

3. The method for retraining a detection model according to claim 2, wherein the screening types comprise one or more combinations including a missing a part (MISS) type, a not good (NG) type, a poor solder (POOR) type, a shift (SHIFT) type, a short circuit (SHORT) type, or a wrong (WRONG) type.

4. The method for retraining a detection model according to claim 1, wherein the step of retraining the object detection model based on an accuracy supervision model estimate that indicates the accuracy information is abnormal comprises:
estimating, by the accuracy supervision model, whether the accuracy information is normal or abnormal; and
triggering, in response to the accuracy information being abnormal, a model training program to retrain the object detection model.

5. The method for retraining a detection model according to claim 4, wherein the step of estimating, by the accuracy supervision model, whether the accuracy information is normal or abnormal comprises:
analyzing the first accuracy information by the accuracy supervision model to generate accuracy estimation information;
calculating a difference between the first accuracy information and the accuracy estimation information; and
in response to the difference being greater than a threshold, determining that the accuracy information is abnormal, or in response to the difference being less than the threshold, determining that the accuracy information is normal.

6. The method for retraining a detection model according to claim 1, wherein the accuracy supervision model is a classification model, an encoder-decoder model, or a recurrent neural network.

7. The method for retraining a detection model according to claim 1, wherein the accuracy supervision model converges by a triplet loss during training.

8. The method for retraining a detection model according to claim 1, wherein the first accuracy information is sequential data comprising a plurality of pieces of time point accuracy data.

9. The method for retraining a detection model according to claim 8, wherein each of the plurality of piece of time point accuracy data comprises a leakage rate and an overkill rate.

10. The method for retraining a detection model according to claim 2, wherein the object detection model after retraining has a higher determining capability for the plurality of screening types than the object detection model before retraining.

11. A non-transitory computer-readable storage medium, storing a plurality of instructions loaded to perform the method for retraining a detection model according to claim 1.

12. An apparatus for retraining a detection model, comprising:
an input unit, configured to obtain first accuracy information of an object detection model; and
a computing unit, configured to retrain the object detection model based on an accuracy supervision model estimate that indicates the accuracy information is abnormal.

13. The apparatus for retraining a detection model according to claim 12, wherein the first accuracy information of the object detection model is second accuracy information indicating that the object detection model determines that a plurality of product photos belong to an identified type in a plurality of screening types, and the plurality of product photos are obtained by respectively photographing a plurality of products of a same product type.

14. The apparatus for retraining a detection model according to claim 12, wherein the computing unit is configured to: estimate, by the accuracy supervision model, whether the accuracy information is normal or abnormal, and trigger, in response to the accuracy information being abnormal, a model training program to retrain the object detection model.

15. The apparatus for retraining a detection model according to claim 14, wherein the computing unit is configured to: analyze the first accuracy information by the accuracy supervision model to generate accuracy estimation information, and calculate a difference between the first accuracy information and the accuracy estimation information, wherein in response to the difference being greater than a threshold, it is determined that the accuracy information is abnormal, or in response to the difference being less than the threshold, it is determined that the accuracy information is normal.

16. The apparatus for retraining a detection model according to claim 12, wherein the accuracy supervision model is a classification model, an encoder-decoder model, or a recurrent neural network.

17. The apparatus for retraining a detection model according to claim 12, wherein the accuracy supervision model converges by a triplet loss during training.

18. The apparatus for retraining a detection model according to claim 12, wherein the first accuracy information is sequential data comprising a plurality of pieces of time point accuracy data.

19. The apparatus for retraining a detection model according to claim 18, wherein each of the plurality of piece of time point accuracy data comprises a leakage rate and an overkill rate.

20. The apparatus for retraining a detection model according to claim 13, wherein the object detection model after retraining has a higher determining capability for the plurality of screening types than the object detection model before retraining.
